(19) United States
(12) Patent Application Publication
(10) Pub. No.: US 2019/0340944 A1
(43) Pub. Date: Nov. 7, 2019

(54) Multimedia Interactive Teaching System and Method

(71) Applicant: SHENZHEN EAGLESOUL TECHNOLOGY CO., LTD., Shenzhen, Guangdong (CN)

(72) Inventors: Jia LIU, Yuncheng, Shanxi (CN); Qiwei LU, Puning, Guangdong (CN)

(73) Assignee: Shenzhen Eaglesoul Technology Co., Ltd., Shenzhen, Guangdong (CN)

(21) Appl. No.: 16/304,125

(22) PCT Filed: Mar. 23, 2017
(86) PCT No.: PCT/CN2017/077786

§ 371 Date: Nov. 21, 2018

(30) Foreign Application Priority Data
Aug. 23, 2016 (CN) 201610705328.2

(51) Int. Cl. G09B 5/06; G09B 5/08; G10L 15/22; G10L 17/02

(52) U.S. Cl. CPC G09B 5/065; G10L 17/02; G10L 15/22; G09B 5/08

(57) ABSTRACT

The present disclosure relates to a multimedia interactive teaching system and method. The system comprises a teaching controller, a learning terminal, a recording device, a speech collection device and a storage device, wherein the recording device is used for acquiring a real-time image and action data; the speech collection device is used for collecting real-time in-class speech information; the teaching controller is used for sending the teaching information collected by the recording device and the speech collection device to the learning terminal; and the storage device is used for storing the teaching information collected by the recording device and the speech collection device, so that a user can review an in-class teaching process by means of on-demand play over network.

### TECHNICAL FIELD

The present disclosure relates to the field of multimedia teaching and, in particular to a multimedia interactive teaching system and method.

### BACKGROUND

Most of the traditional multimedia classrooms use modern teaching devices, such as projectors, video presentation stands, computers, electric screens, amplifiers, speakers and electric curtains, to achieve the purposes of teaching, academic exchanges and lectures, so that the existing multimedia teaching requirements can be basically met. However, there are some significant problems in the use of the traditional multimedia classrooms and projection classrooms, which mainly lie in the following aspects:

Firstly, devices in the traditional multimedia classroom are comprised of a projector, a computer, an electronic whiteboard and a speaker, etc., with complicated lines making the devices often fail, thereby increasing an enormous cost for later maintenance;

Secondly, in the traditional multimedia classroom, numerous devices are installed near the classroom platform, while the platform is also the region where students often carry out activities, such that the probability of damages to the devices is very high, and personal injury is liable to be caused to active students.

Thirdly, in the traditional multimedia classroom, it is generally dominated by teacher's explanation, while students are passively accepting for most of the time and are unable to achieve interactive learning, especially physical and chemical situational teaching, which cannot replace the real participation process, such that the teacher can merely teach in accordance with the established lesson preparation plan, thereby having a poor flexibility in the class, making the teacher have less room to play, and thus reducing the teaching effectiveness.

In order to solve the above-mentioned problems, some wireless network-based teaching platform systems have been disclosed, and these systems solve the problems existing in a multimedia classroom of multiple devices, complicated connections and lack of interaction, such as:

CN101154320A (date of publication: 2 Apr. 2008) discloses an electronic class interactive teaching platform system based on a local area network, the system comprising an in-class teaching resource library, an in-class teaching platform, an in-class teaching interface, an in-class teaching functional module, a teacher lesson-preparation system and resource sharing, wherein the in-class teaching resource library provides teaching resources to the in-class teaching platform, and teachers and students enter respective in-class teaching interfaces by logging in the in-class teaching platform, with the in-class teaching interface being divided into: a teacher interface, a student interface and a demonstration interface, wherein the teachers conduct teaching management through three modules, namely a teaching module, a student management module and an auxiliary function module in the teacher teaching interface. The teachers newly add or edit the teaching resources and determine teaching plans through the teacher lesson-preparation system. The in-class teaching resource library can share resources with network resources over the Internet, and parents obtain student learning records and teacher teaching records by means of resource sharing.

CN103927909A (date of publication: 16 Jul. 2014) discloses an interactive teaching system of a touching mobile terminal, comprising a teacher terminal, a classroom computer, and a plurality of learning terminals, with the teacher terminal, the classroom computer and the plurality of learning terminals constituting, in interconnection, an interactive teaching system over a local area network, wherein the teacher terminal and the plurality of learning terminals access the local area network in a wireless manner; the classroom computer accesses the local area network in a wired or wireless manner; the classroom computer is a server of the interactive teaching system; the classroom computer is in interconnection with the teacher terminal through the private socket communication protocol, the public RFB protocol and the video stream; and the plurality of learning terminals are in interconnection with the classroom computer through the private socket communication protocol.

The above-mentioned interactive teaching system also has such a problem: the interaction between teacher and students in the wireless network platform cannot reach a barrier-free degree, and the system cannot automatically recognize and record information about a speech interaction between the teacher and the students, and their own speech records in a class cannot be reviewed afterwards. The existing teaching system firstly needs to be equipped with a teaching terminal specific to a person; secondly, if a student wants to speak through the learning terminal, it is also necessary to align with a microphone or start the microphone to perform speech communication, failing to communicate with the teacher carefree. For example, CN 105306861 discloses a network teaching recording and broadcasting method, in which a method for separately storing three types of data streams is used; however, there is still such a problem in the aspect of speech storage: such a speech recording function is completely carried out in accordance with actual conditions without recognizing the identity of a speaker and without reconstructing the speech of the speaker, so that if the recording environment is noisy, the recorded information is also noisy and the scene can barely be reproduced effectively. This does not provide a personalized service, for example, when a student only wants to hear what he or she said or what the teacher said but does not want to hear what other students said, they cannot make a selection during playback, however.

In addition, there is still a problem in the existing teaching platform: the teacher terminal is usually fixed, and a teacher needs to make communication on the set platform or arrangement place of the teacher terminal, thereby lacking deep interaction with the students. This does not make it possible for the teacher to go to the students for more active interaction as traditional teaching. For this, a wireless control apparatus is disclosed, for example:

CN105185176A (date of publication: 23 Dec. 2015) discloses a wireless handheld device based on informatized teaching, in which the wireless handheld device is wirelessly connected to a teaching device through Bluetooth techniques or 2.4G techniques, and the teaching device is a computer, an electronic whiteboard or a liquid crystal touch screen terminal, wherein the wireless handheld device comprises a handheld device body; a microphone is arranged on an upper part of the handheld device body; a front panel of the handheld device body is provided with a touch screen supporting multi-point touch operations; there are two physical buttons, left and right, below the touch screen; an accommodation groove for accommodating a USB wireless receiver is arranged on a lower part of the handheld device body; the handheld device can wirelessly transmit a multi-point touch signal, a mouse operation signal and a simulation keyboard trigger signal, so as to perform wireless remote control on the functions of an electronic blackboard, an electronic teaching pole, an electronic chalk, a straight line tool, a graphical tool, a blackboard eraser, a magnifier, a tool bar, page up, page down, courseware saving, class exit, and picture or video insertion, text insertion and learning guidance insertion, thereby achieving teaching actions, and collecting and transmitting class explanations from a teacher and speeches from students for recording of the speeches in the class.

The existing Bluetooth wireless remote control apparatus cannot realize flexible control of speech, which is mainly realized in a wireless control manner by integrating basic operation apparatuses such as a keyboard and a mouse, and the functions thereof still have room for improvement.

### SUMMARY OF THE DISCLOSURE

In view of the deficiencies of the existing schemes, the technical problem to be solved by the present disclosure is to provide a multimedia interactive teaching system and method, which mainly improve a wireless remote control apparatus and an operation method therefor, a high-speed photographic instrument mechanism and an operation method therefor, and use a speech recognition clustering technology to perform segmentation and clustering on the obtained teaching speech information to recognize the corresponding speaker and separately store these pieces of speech information, thereby solving some problems existing in the existing schemes, and reducing teaching costs, improving the teaching flexibility and interactivity and improving the teaching effectiveness by means of the wireless multimedia information interactive teaching method in the present disclosure.

The present disclosure provides a multimedia interactive teaching system, which comprises a teaching controller 100, a learning terminal 103, a recording device, a speech collection device 106 and a storage device 107,

the recording device is used for acquiring a real-time image and action data;

the speech collection device 106 is used for collecting real-time in-class speech information;

the teaching controller 100 is used for sending the teaching information collected by the recording device and the speech collection device 106 to the learning terminal 103 and/or a display screen 102 additionally arranged for centralized presentation; and

the storage device 107 is used for storing the teaching information collected by the recording device and the speech collection device, so that a user can review an in-class teaching process by means of on-demand play over network.

The teaching controller 100 comprises a speaker segmentation module, a speaker clustering module and a voiceprint recognition module, which are respectively used for performing speaker segmentation, speaker clustering and voiceprint recognition processing on the collected speech information, so as to extract speech information about each speaker and recognize the identity of the speaker according to a voiceprint template obtained from training.

a speaker identity identifier and a timestamp identifier which is unifiedly generated by the system are added to the extracted speech information, so as to form a series of independent pieces of speech information taking a speaker identity as an identifier and having a timestamp, and then save same.

when reviewing a class by means of on-demand play over network, the user first selects a speech that he or she wants to hear by selecting a speaker, and then plays the speech.

the speaker segmentation is used for looking for a turning point for speaker switching, including single turning point detection and multiple turning points detection, wherein

the single turning point detection comprises a distance-based sequence detection, a cross detection and a turning point confirmation; and

the multiple turning points detection is used for looking for a plurality of speaker turning points in a whole speech segment, and is completed on the basis of the single turning point detection, comprising:

step 1): firstly, setting a large time window with a length of 5 to 15 seconds, and performing the single turning point detection within the window;

step 2): if no speaker turning point is found in the preceding step, moving the window backward by 1 to 3 seconds, and repeating step 1 until a speaker turning point is found or the speech segment ends; and

step 3): if a speaker turning point is found, recording this turning point and setting a starting point of the window at this turning point, and repeating steps 1) and 2).

a confirmation formula for the turning point is:

$$\{ \begin{matrix}{\sum }_{i = 0}^{N} sign ( d ( i ) - {d}_{cross} ) > 0 & accepting the turning point \\ {\sum }_{i = 0}^{N} sign ( d ( i ) - {d}_{cross} ) < 0 & rejecting the turning point\end{matrix}$$

where sign(⋅) is a sign function, and d_{cross} is a distance value at the crossing of two distance curves; and The distance curve refers to: a speech segment of 1 to 3 seconds at the very beginning of the speech is taken as a template window, and then the distance between this template and each sliding segment (with the same length as that of the template) is calculated, and in the present disclosure, a “generalized likelihood ratio” is adopted as a metric distance, so that the distance curve can be obtained.

By using a section of a distance curve of the speaker from a start to a cross point, d (i) in the formula is a distance calculated within this section, and if a final result is positive, this point is accepted as the speaker turning point; and if the final result is negative, this point is rejected to be the speaker turning point.

The recording device comprises a teaching high-speed photographic instrument 104 and an electronic whiteboard 105,

wherein the teaching high-speed photographic instrument 104 is used for acquiring a real-time image and outputting same to the teaching controller 100, and

the electronic whiteboard 105 is used for acquiring the action data and outputting same to the teaching controller 100.

The teaching high-speed photographic instrument 104 comprises a working table 1040 and a wireless transmission module 1045, wherein

an arm lamp 1041 is arranged respectively at each of both sides of the working table 1040, and

a transmission antenna of the wireless transmission module 1045 is arranged on a non-light-emitting side part of at least one of the arm lamps 1041.

The system further comprising a wireless remote controller 101 for implementing wireless control of the teaching controller 100,

wherein the wireless remote controller 101 comprises a touch screen 1012, a microphone 1010, an external microphone jack 1011 and a wireless transmission module 1013.

The wireless remote controller 101 further comprises a speech recognition module 1014, an instruction storage module 1015 and an instruction matching module 1016, wherein

the speech recognition module 1014 is used for recognizing the speech information input by the user, and if a set action character is detected, extracting operation information contained in the speech after the action character while not transmitting this speech segment to the teaching controller 100, and if no set action character is detected, synchronously transmitting the speech information to the teaching controller 100;

the instruction storage module 1015 is used for storing information about instructions that can control the teaching controller 100; and

the instruction matching module 1016 is used for matching the operation information with the instructions stored in the instruction storage module 1015, and implementing corresponding instruction operations after the matching is successful.

The touch screen 1012 is used for

simulating a virtual keyboard and typing characters with the virtual keyboard;

simulating a mouse button to implement a mouse click operation; and

acquiring a sliding track and generating a hand-drawn graphic according to the sliding track.

The wireless remote controller 101 records the extracted operation information and the instruction matching therewith, and displays same on the touch screen 1012 of the wireless remote controller, and displays common instructions in a fixed position on the touch screen 1012, so that the user repeats such an instruction action through click operations.

The wireless remote controller 101 further comprises an external microphone jack 1011 which is arranged at the bottom of the wireless remote controller 101 and is used for acquiring the speech information via an outer dedicated microphone.

The teaching controller 100 regularly updates the instructions stored in the wireless remote controller 101.

The speech information transmitted to the teaching controller 100 by the wireless remote controller 101 is also saved to the storage device 107; and

The teaching controller 100 further comprises a speaker deduplication module for removing duplicated speeches originating from the wireless remote controller 101 and the speech collection device 106 according to a voiceprint model.

The present disclosure further provides a multimedia interactive teaching method, comprising:

step S1, turning on a teaching controller 100, and establishing, by a recording device, a learning terminal 103, a speech collection device 106 and a storage device 107, respectively, a connection with the teaching controller 100;

step S2, acquiring, by the recording device, a real-time image and action data and transmitting same to the teaching controller 100, and acquiring, by the speech collection device 106, in-class speech information and transmitting same to the teaching controller 100;

step S3, processing, by the teaching controller 100, the received real-time image, action data and speech information, and then storing same to the storage device 107, wherein the storage device 107 is a local memory or a network cloud memory and any combination thereof;

step S4, sending, by the teaching controller 100, teaching data of one or any combination of the received real-time image, action data and speech information to the learning terminal 103 and/or a display screen 102 additionally arranged for centralized presentation;

step S5, receiving and playing, by the learning terminal 103, the teaching data sent by the teaching controller 100; and

step S6, accessing the teaching controller 100 over a network, and obtaining at least one of the real-time image, the action data and the speech information stored on the storage device 107, thereby implementing the playback of an in-class teaching process.

In the step S3, the process of processing, by the teaching controller 100, the received teaching data comprises:

speaker segmentation, speaker clustering and voiceprint recognition, which are respectively used for performing speaker segmentation, speaker clustering and voiceprint recognition processing on the collected speech information, so as to extract speech information about each speaker and recognize the identity of the speaker according to a voiceprint template obtained from training.

a speaker identity identifier and a timestamp identifier which is unifiedly generated by the system are added to the extracted speech information, so as to form a series of independent pieces of speech information taking a speaker identity as an identifier and having a timestamp, and then save same.

In step S6,

when reviewing a class by means of on-demand play over network, the user first selects a speech that he or she wants to hear by selecting a speaker, and then plays the speech.

the speaker segmentation is used for looking for a turning point for speaker switching, including single turning point detection and multiple turning points detection, wherein

the single turning point detection comprises a distance-based sequence detection, a cross detection and a turning point confirmation; and

the multiple turning points detection is used for looking for a plurality of speaker turning points in a whole speech segment, and is completed on the basis of the single turning point detection, comprising:

step 1): firstly, setting a large time window with a length of 5 to 15 seconds, and performing the single turning point detection within the window;

step 2): if no speaker turning point is found in the preceding step, moving the window backward by 1 to 3 seconds, and repeating step 1 until a speaker turning point is found or the speech segment ends; and

step 3): if a speaker turning point is found, recording this turning point and setting a starting point of the window at this turning point, and repeating steps 1) and 2).

A confirmation formula for the turning point is:

$$\{ \begin{matrix}{\sum }_{i = 0}^{N} sign ( d ( i ) - {d}_{cross} ) > 0 & accepting the turning point \\ {\sum }_{i = 0}^{N} sign ( d ( i ) - {d}_{cross} ) < 0 & rejecting the turning point\end{matrix}$$

where sign(⋅) is a sign function, and d_{cross} is a distance value at the crossing of two distance curves; and the distance curve refers to: a speech segment (1 to 3 seconds) at the very beginning of the speech is taken as a template window, and then the distance between this template and each sliding segment (with the same length as that of the template) is calculated, and in the present disclosure, a “generalized likelihood ratio” is adopted as a metric distance, so that the distance curve can be obtained.

wherein by using a section of a distance curve of the speaker from a start to a cross point, d (i) in the formula is a distance calculated within this section, and if a final result is positive, this point is accepted as the speaker turning point; and if the final result is negative, this point is rejected to be the speaker turning point.

The recording device comprises a teaching high-speed photographic instrument 104 and an electronic whiteboard 105,

wherein the teaching high-speed photographic instrument 104 is used for acquiring a real-time image and outputting same to the teaching controller 100, and

the electronic whiteboard 105 is used for acquiring the action data and outputting same to the teaching controller 100.

The teaching high-speed photographic instrument 104 comprises a working table 1040 and a wireless transmission module 1045, wherein

an arm lamp 1041 is arranged respectively at each of both sides of the working table 1040, and

a transmission antenna of the wireless transmission module 1045 is arranged on a non-light-emitting side part of at least one of the arm lamps 1041.

The system further comprising a wireless remote controller 101 for implementing wireless control of the teaching controller 100,

wherein the wireless remote controller 101 comprises a touch screen 1012, a microphone 1010, an external microphone jack 1011 and a wireless transmission module 1013.

The wireless remote controller 101 further comprises a speech recognition module 1014, an instruction storage module 1015 and an instruction matching module 1016, wherein

the speech recognition module 1014 is used for recognizing the speech information input by the user, and if a set action character is detected, extracting operation information contained in the speech after the action character while not transmitting this speech segment to the teaching controller 100, and if no set action character is detected, synchronously transmitting the speech information to the teaching controller 100;

the instruction storage module 1015 is used for storing information about instructions that can control the teaching controller 100; and

the instruction matching module 1016 is used for matching the operation information with the instructions stored in the instruction storage module 1015, and implementing corresponding instruction operations after the matching is successful.

The touch screen 1012 is used for

simulating a virtual keyboard and typing characters with the virtual keyboard;

simulating a mouse button to implement a mouse click operation; and and/or

acquiring a sliding track and generating a hand-drawn graphic according to the sliding track.

The wireless remote controller 101 records the extracted operation information and the instruction matching therewith, and displays same on the touch screen 1012 of the wireless remote controller, and displays common instructions in a fixed position on the touch screen 1012, so that the user repeats such an instruction action through click operations.

The wireless remote controller 101 further comprises an external microphone jack 1011 which is arranged at the bottom of the wireless remote controller 101 and is used for acquiring the speech information via an outer dedicated microphone.

The teaching controller 100 regularly updates the instructions stored in the wireless remote controller 101.

The speech information transmitted to the teaching controller 100 by the wireless remote controller 101 is also saved to the storage device 107; and

The teaching controller 100 further comprises a speaker deduplication module for removing duplicated speeches originating from the wireless remote controller 101 and the speech collection device 106 according to a voiceprint model.

In the step S5, the process of receiving and playing, by the learning terminal 103, the teaching data comprises:

step S41, logging in, by the user, the learning terminal 103 after passing an identity verification;

step S42, receiving, by the learning terminal 103, the teaching data sent by the teaching controller 100;

step S43, obtaining, by the learning terminal 103 by parsing the teaching data, the real-time image, the action data and the speech information, and displaying same on the learning terminal 103, such as parsing and displaying the received real-time image by means of DirectX; and

step S44, determining whether the receiving of the teaching data is completed, and if so, ending the receiving process, and if not, returning to the step S42.

the learning terminal 103 is provided with a buffer for accommodating a preset number of real-time images, and when receiving a real-time image, the learning terminal 103 first determines whether the real-time image can be loaded into the buffer and compares the serial number of the received image with the serial number of an image displayed by the learning terminal 103, and writes the received image into the buffer if the difference between the serial numbers is less than the number of real-time images that the buffer can accommodate, and discards the real-time image and continues with the comparison if the difference between the serial numbers is greater than the number of real-time images that the buffer can accommodate, and re-receives a real-time image sent by the teaching terminal until the real-time image can be stored to the buffer.

When the difference between the serial numbers is greater than the number of real-time images that the buffer can accommodate, the learning terminal first determines whether the received image frame is a synchronous frame, if so, checks whether the image frame at the tail of a buffer queue is a synchronous frame, and if so, discards the image frame and places the received new image frame at a queue-tail position, and if not, continues with the query for a synchronous frame from the buffer queue so as to find a synchronous frame, and then discards the synchronous frame and the received image; and if there is no synchronous frame in the queue, the learning terminal places the received image frame at the tail of the queue to cover original data, and waits for the completion of the reception of synchronous frames through repeated receptions and displays the synchronous frames on the learning terminal 103.

In the step S6, the on-demand playback process is as follows:

step S51, sending, by the learning terminal 103 of the user, an on-demand playback request to the teaching controller 100 over the network;

step S52, acquiring, by the teaching controller 100 in responsive to the on-demand playback request, a corresponding teaching information list according to the content of the request, and sending the teaching information list to the learning terminal 103;

step S53, selecting, by the user on the learning terminal 103, desired pieces of information from the teaching information list, wherein these pieces of information comprise the image information, the action information, as well as the speech information which is distinguished in accordance with the speakers;

step S54, sending, by the teaching controller 100 according to the user's selection, corresponding teaching information to the learning terminal 103; and

step S55, reconstructing, by the learning terminal 103 in accordance with timestamps, the received teaching information, and displaying the reconstructed teaching information locally.

### BRIEF DESCRIPTION OF THE DRAWINGS

FIG. 1 is a schematic diagram of a multimedia interactive teaching system according to the present disclosure;

FIG. 2 is a high-speed photographic instrument of a multimedia interactive teaching system according to the present disclosure;

FIG. 3 is a front view of a wireless remote controller according to the present disclosure;

FIG. 4 is a side view of a wireless remote controller according to the present disclosure;

FIG. 5 is a function frame diagram of a wireless remote controller according to the present disclosure;

FIG. 6 is a flowchart of a multimedia interactive teaching method according to the present disclosure;

FIG. 7 is a schematic diagram of a process of speaker segmentation and clustering according to the present disclosure;

FIG. 8 is a flowchart of single turning point detection according to the present disclosure;

FIG. 9 is a schematic diagram of a distance-based sequence detection according to the present disclosure;

FIG. 10 is a distance curve for a sequence detection according to the present disclosure;

FIG. 11 is a schematic diagram of looking for a second speaker speech template according to the present disclosure;

FIG. 12 is a schematic diagram of cross detection of speaker turning points according to the present disclosure;

FIG. 13 is a schematic diagram of incorrect turning point detection according to the present disclosure;

FIG. 14 is a schematic diagram of turning point confirmation according to the present disclosure;

FIG. 15 is a block diagram of an IHC algorithm according to the present disclosure;

FIG. 16 is a flowchart of receiving and playing, by a learning terminal, teaching data in real time according to the present disclosure;

FIG. 17 is a schematic diagram of a process of image buffer processing of a learning terminal according to the present disclosure; and

FIG. 18 is a schematic diagram of a learning terminal reviewing an in-class teaching process by means of on-demand play over network according to the present disclosure.

### DETAILED DESCRIPTION OF EMBODIMENTS

The specific embodiments of the present disclosure will be further described in detail below in conjunction with the accompanying drawings.

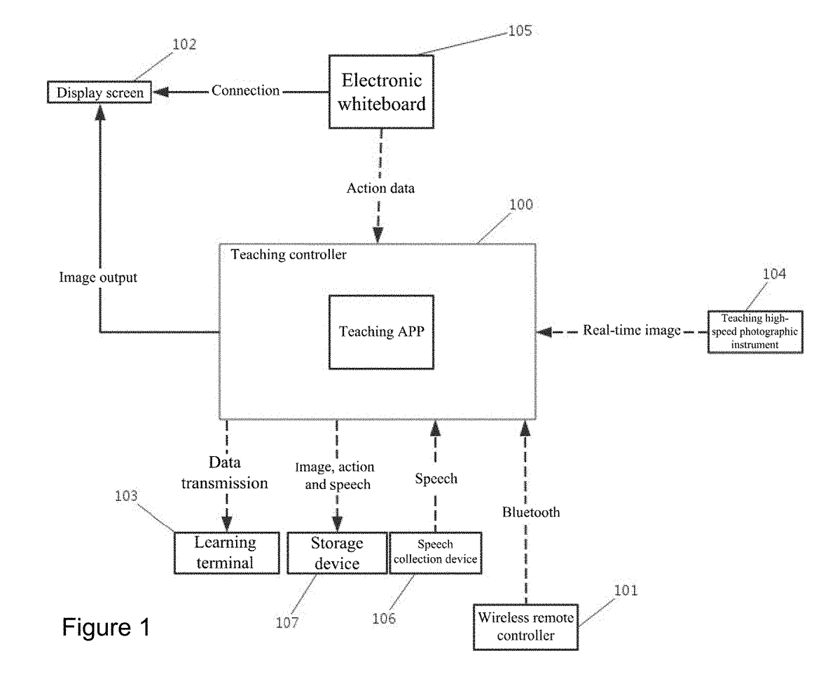

As shown in FIG. 1, a multimedia interactive teaching system according to the present disclosure comprises: a teaching controller 100, a wireless remote controller 101, a display screen 102, a learning terminal 103, a recording device, a speech collection device 106 and a storage device 107, wherein

the recording device comprises a teaching high-speed photographic instrument 104 and an electronic whiteboard 105, which are respectively used for acquiring a real-time image and action data and transmitting same to the teaching controller 100, so as to display, under the control of the teaching controller 100, the real-time image on the display screen 102 or reproduce the operation situation according to the action data.

The wireless remote controller 101 is used for inputting a control instruction, text information and speech information, and transmitting, to the teaching controller 100, these pieces of information in a wireless manner, such as Bluetooth, a local area network, WIFI, etc.

Preferably, a user can interact with the wireless remote controller 101 through speech, and the remote controller 101 can parse a control instruction contained in the speech and then issues a corresponding control instruction to the teaching controller 100 without issuing such an instruction through a specific action operation.

The speech collection device 106 can be arranged on a ceiling of the classroom in a manner of at least one circular microphone array, or other suitable positions, without arranging the speech collection device on each seat. The speech collection device 106 is mainly used for collecting speech information for the time when students in the classroom discuss or answer a question, and transmitting the collected speech information to the teaching controller 100.

The teaching controller 100 is arranged at a teacher end; the teaching controller 100 is installed with a teaching APP or a PC software client; and the teaching controller 100 can load, through the teaching APP or the PC software client and according to the received control instruction from the wireless remote controller 101, the real-time image and/or action data collected by the recording device on the display screen 102, or send teaching data of one of or any combination of the real-time image, action data and speech information to the learning terminal 103, and separately store, in accordance with different types, the three types of data to the storage device 107 for students to review an in-class teaching process by means of on-demand play over network afterwards. The storage device 107 can be a local memory, and can also be a network cloud memory, and a combination thereof. The action data comprises data of a teacher operating documents on the electronic whiteboard, data of drawing a graphic, etc.

Preferably, the teaching controller 100 of the present disclosure comprises a speaker segmentation module, a speaker clustering module and a voiceprint recognition module, which are used for performing processing such as speaker segmentation, speaker clustering and voiceprint recognition on the collected speech information, so as to extract speech information about each speaker and recognize the identity of the speaker according to an existing trained voiceprint template. Furthermore, a speaker identifier and a unified timestamp which is generated by the system are added to the extracted speech, so that the user can select to play a speech that he or she wants to hear when reviewing by means of on-demand playback over network, for example, to play a speech from a teacher of what he or she wants to hear, while shielding the other speeches, or to select to play back speeches of the teacher and the user himself or herself when he or she wants to hear what the teacher and the user himself or herself said. This can solve the problem that live recording cannot be heard clearly when it is noisy on the spot with numerous people speaking, and add many options for review afterwards, thereby improving the user experience and saving on time.

The display screen 102 is an LED display screen or a television screen, etc.

The learning terminal 103 is arranged at a student end, and the learning terminal 103 is installed with a learning APP or a PC software client associated with the teaching APP or PC software client, so as to receive and play teaching data of one of or any combination of the real-time image, action data and speech information sent by the teaching controller 100.

According to the teaching system of the present disclosure, the teaching controller 100 is internally provided with a teaching APP or a PC software client, and the teaching APP or the PC software client simultaneously access a recording device for a demonstration operation on the electronic whiteboard and input of a video and a picture. The wireless remote controller 101 is used for implementing the control, operation and entering of a speech, and the teaching controller 100 is operated through a Bluetooth signal output by the wireless remote controller 101. The wireless remote controller 101 can provide a virtual keyboard, a mouse, handwriting, etc., to perform a wireless operation on the teaching APP or the PC software client. Moreover, the speech information entered by the wireless remote controller 101 can be transmitted to each learning terminal 103, and the action data can be presented on the display screen 102 to facilitate situational teaching. The teacher can obtain the close shot of the current real-time experiment, textbooks, test questions, etc., and synchronize same to the display screen or each learning terminal in real time, so that students at any corner can clearly obtain the explanation content from the teacher, and at the same time, passive learning can be turned to active learning through the teaching APP or PC software client, thereby improving the learning initiative of the students.

The recording device comprises:

a teaching high-speed photographic instrument 104 for acquiring a real-time image and outputting same to the teaching controller 100; and

an electronic whiteboard 105 for acquiring action data and outputting same to the teaching controller 100.

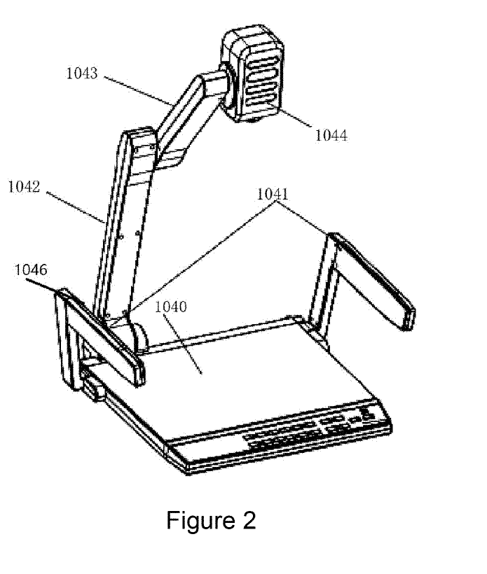

As shown in FIG. 2, the teaching high-speed photographic instrument 104 comprises: a working table 1040, wherein an arm lamp 1041 is arranged respectively at each of both sides of the working table 1040, a lower support arm 1042 is arranged on the working table 1040, an upper support arm 1043 is arranged on the lower support arm 1042, a camera 1044 is arranged on the upper support arm 1043, the camera 1044 faces toward the working table 1040, and the lower support arm 1042 and the upper support arm 1043 are rotatably connected via a damper shaft.

Preferably, the teaching high-speed photographic instrument 104 further comprises a wireless transmission module 1045, such as Bluetooth, a wireless network, WIFI, etc., thereby implementing a wireless connection with the teaching controller 100 and transmitting data in real time, so that a dedicated connection cable can be omitted, and it is convenient to move a device and easy to use.

Preferably, a transmission antenna 1046 of the wireless transmission module 1045 is arranged on a non-light-emitting side part of at least one of the arm lamps 1041, and such an arrangement manner can increase the wireless transmission distance without occupying an extra space, and does not need specially arrange other apparatuses.

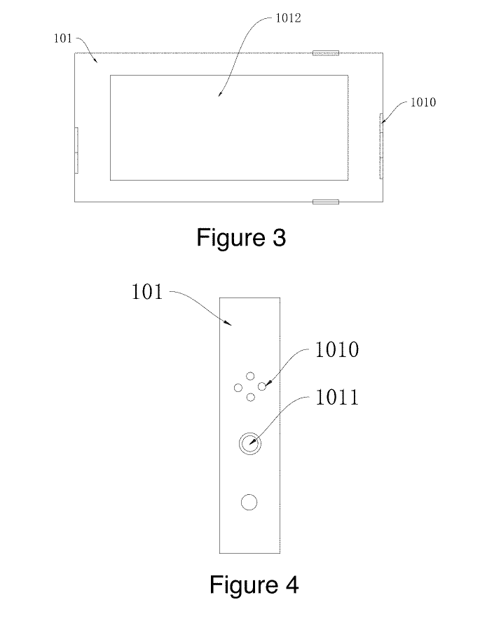

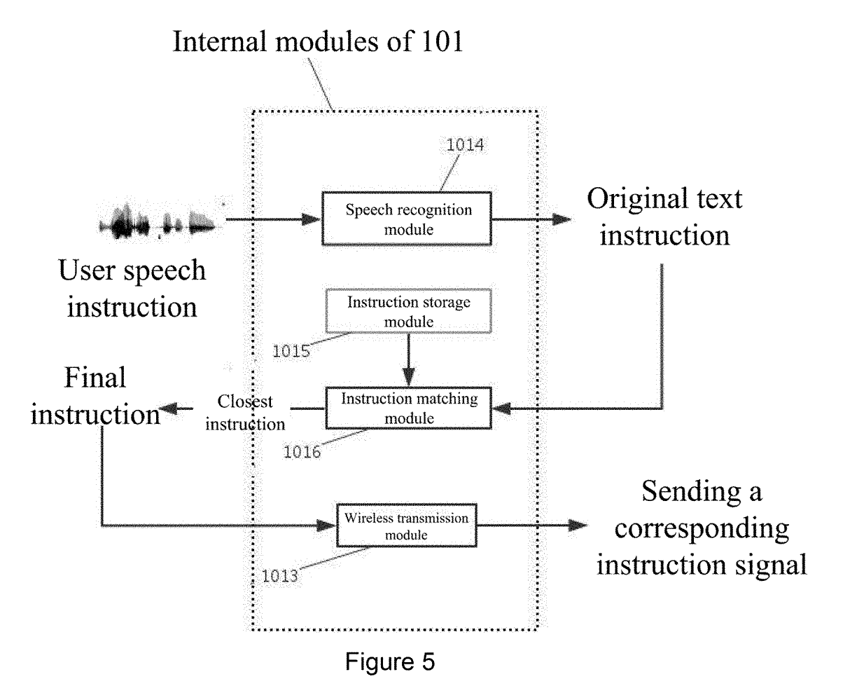

As shown in FIGS. 3-5, the wireless remote controller 101 comprises a touch screen 1012, a noise-reduced microphone 1010, an external microphone jack 1011 and a wireless transmission module 1013.

Preferably, the wireless remote controller 101 further comprises a speech recognition module 1014, an instruction storage module 1015, an instruction matching module 1016, etc.

The touch screen 1012 can be used for:

simulating a virtual keyboard and typing characters with the virtual keyboard;

simulating a mouse button to implement a mouse click operation; and

acquiring a sliding track and generating a hand-drawn graphic according to the sliding track.

The noise-reduced microphone 1010 is used for acquiring speech information. The external microphone jack 1011 is arranged at the bottom of the wireless remote controller 101 and is used for acquiring the speech information via an outer dedicated microphone, for example a miniature microphone carried around by a teacher. The wireless transmission module 1013 is used for performing wireless data transmission with the teaching controller 100.

Preferably, the speech information input by the user can also be recognized via the speech recognition module 1014 to extract the operation information therein without having to manually perform some operations. The instruction matching module 1016 matches the operation information with instructions stored in the instruction storage module 1015, and implements corresponding operations after the matching is successful, and gives a prompt if the matching is unsuccessful. For example, the teacher says an instruction, automatic page turning. The speech recognition module 1014 first recognizes an “instruction” so as not to transmit this speech segment to the teaching controller 100 any more but further parse “automatic page turning”, match same with the stored instruction, and then issue an automatic page turning instruction. If it is not an instruction speech, the speech information would be synchronously transmitted to the teaching controller 100.

Preferably, the wireless remote controller 101 records the extracted operation information and an instruction matching therewith, and can display same on the touch screen 1012 of the wireless remote controller. More preferably, the most common instructions are displayed in a fixed position on the touch screen 1012, so that the user can also repeat such an instruction action through click operations.

Preferably, the stored instructions in the wireless remote controller 101 can be updated and synchronized by the teaching APP or the PC software client of the teaching controller 100 in a wireless manner, thereby implementing the update and matching of instructions for the device, and facilitating control.

For non-instructed speech information transmitted by the wireless remote controller 101, the teaching controller 100 separately saves these pieces of information, and eliminates other noises for pure speech information according to a teacher speech model.

The speech sampling rate of the wireless remote controller 101 is 44.1 KHz/16 bit, and the wireless transmission distance thereof is greater than or equal to 10 m. Specifically, the specification parameters of the wireless remote controller 101 may be as follows:

1. 2.4G-based wireless transmission, Bluetooth pairing in a one-to-one form, for real-time control of the sending of instructions, speech information and keyboard/control signals;

2. Touching keyboard, wherein a finger or pen can both operate a virtual keyboard;

3. Touching brush hand-drawing, supporting absolute coordinate output and teaching APP or PC software client, and being compatible with the support of drawing and handwriting;

4. Touching mouse for realizing left and right keys, moving, dragging, etc.;

5. Data from instructions, brush, keyboard and mouse being transmitted in a transparent transmission SPP mode, using RF4CE standard;

6. The speech sampling rate being 44.1 KHz/16 bit, the wireless transmission distance being greater than or equal to 10 M, a microphone mode supporting clear channel automatic search;

7. Real-time speech transmission, built-in microphone, 10 cm-distance sound-pickup, external microphone socket, ENC noise elimination;

8. Set-top box control, having switching keys of Home, back, top, bottom, left, right, etc.;

9. Size: 119*60*9 mm, size of touch screen: 121*60 mm, resolution: 1024*560;

10. A battery of 3.7V/800 mA 5V/1 A (micro USB plug).

The teaching controller of the present disclosure is installed with an Android 4.4 system. The specific specification parameters of the teaching controller are as follows:

1. Android 4.4, LPDDR3EMMC, 1.8 GHz eight-core processor;

2. RAM: 2 GB DDR3, ROM Flash: 8 GB, 64 GB maximumly supported for SD card;

3. Network connection: internal WIFI, internal Built-in Bluetooth, Ethernet RJ 45;

4. A display interface being an HDMI interface.

The learning terminal 103 may comprise a local learning terminal, and may also comprise a remote learning terminal, wherein the local learning terminal performs data interaction with the teaching controller 100 based on a wireless local area network, and the remote learning terminal performs data interaction with the teaching controller 100 based on an Internet cloud platform.

Teachers and students can organize teaching through a multimedia teaching system in which the teacher can release videos while the students can learn related knowledge by remotely watching the videos. The teaching controller sends teaching information to the learning terminal, and the student can see, through the screen of the learning terminal, information about a related document of the teacher and operations of the teacher on the document.

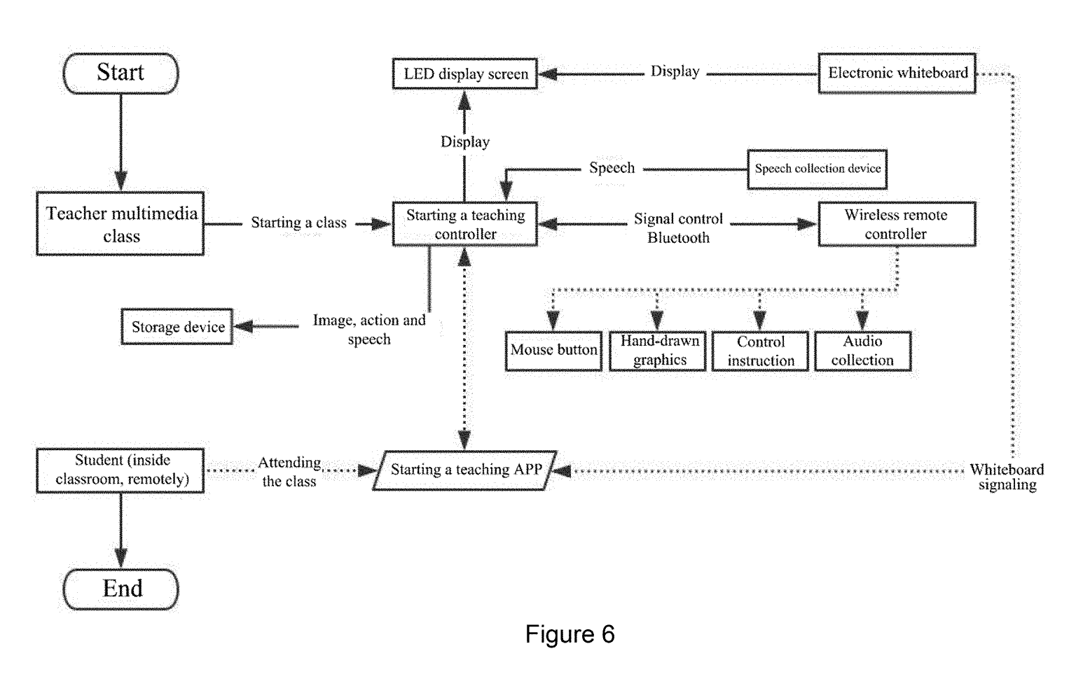

As shown in FIG. 6, a multimedia interactive teaching method according to the present disclosure comprises the steps of:

step S1, turning on a teaching controller 100, and establishing, by a recording device, a learning terminal 103, a speech collection device 106 and a storage device 107, respectively, a connection with the teaching controller 100;

step S2, acquiring, by the recording device, a real-time image and action data and transmitting same to the teaching controller 100, and acquiring, by the speech collection device 106, in-class speech information and transmitting same to the teaching controller 100;

alternatively, transmitting a control instruction, text information and/or speech information input via the wireless remote controller 101 to the teaching controller 100 in a wireless manner, such as Bluetooth, a wireless network, WIFI, etc.;

step S3, processing, by the teaching controller 100, the received real-time image, action data and speech information, and then storing same to the storage device 107, wherein the storage device 107 is a local memory or a network cloud memory and any combination thereof;

step S4, sending, by the teaching controller 100, teaching data of one or any combination of the received real-time image, action data and speech information to the learning terminal 103 and/or a display screen 102 additionally arranged for centralized presentation;

step S5, receiving and playing, by the learning terminal 103, the teaching data sent by the teaching controller 100; and

step S6, accessing the teaching controller 100 over a network, and obtaining at least one of the real-time image, the action data and the speech information stored on the storage device 107, thereby implementing the playback of an in-class teaching process.

The speech information comprises information collected by the speech collection device 106, and may also comprise speech information collected by the wireless remote controller 101.

Preferably, in order to enter a manipulation instruction and text information, in the step S2:

a control instruction input by the wireless remote controller 101 comprises a mouse click operation instruction implemented by simulating a mouse button on the touch screen 1012; and

text information input by the wireless remote controller 101 comprises characters typed by simulating a virtual keyboard on the touch screen 1012 and using the virtual keyboard.

Preferably, in the step S2:

A user can interact with the wireless remote controller 101 through speech, and the remote controller 101 can parse a control instruction contained in the speech and then issue a corresponding control instruction to the teaching controller 100 without issuing such an instruction through a specific action operation.

Preferably, the wireless remote controller 101 further comprises a speech recognition module 1014, an instruction storage module 1015, and an instruction matching module 1016.

The touch screen 1012 can be used for:

simulating a virtual keyboard and typing characters with the virtual keyboard;

simulating a mouse button to implement a mouse click operation; and

acquiring a sliding track and generating a hand-drawn graphic according to the sliding track, and using action data generated from the sliding track to replace the action data acquired by the recording device.

The noise-reduced microphone 1010 is used for acquiring speech information. The external microphone jack 1011 is arranged at the bottom of the wireless remote controller 101 and is used for acquiring the speech information via an outer dedicated microphone, for example a miniature microphone carried around by a teacher. The wireless transmission module 1013 is used for performing wireless data transmission with the teaching controller 100.

Preferably, the speech information input by the user can also be recognized via the speech recognition module 1014 to extract the operation information therein without having to manually perform some operations. The instruction matching module 1016 matches the operation information with instructions stored in the instruction storage module 1015, and implements corresponding operations after the matching is successful, and gives a prompt if the matching is unsuccessful. For example, the teacher says an instruction, automatic page turning. The speech recognition module 1014 first recognizes an “instruction” so as not to transmit this speech segment to the teaching controller 100 any more but further parse “automatic page turning”, match same with the stored instruction, and then issue an automatic page turning instruction. If it is not an instruction speech, the speech information would be synchronously transmitted to the teaching controller 100.

Preferably, the wireless remote controller 101 records the extracted operation information and an instruction matching therewith, and can display same on the touch screen 1012 of the wireless remote controller.

More preferably, the most common instructions are displayed in a fixed position on the touch screen 1012, so that the user can also repeat such an instruction action through click operations.

Preferably, the stored instructions in the wireless remote controller 101 can be updated and synchronized by the teaching APP or the PC software client of the teaching controller 100 in a wireless manner, thereby implementing the update and matching of instructions for the device, and facilitating control.

For non-instructed speech information transmitted by the wireless remote controller 101, the teaching controller 100 separately saves these pieces of information, and eliminates other noises for pure speech information according to a teacher speech model.

Preferably, in the step S5:

The learning terminal 103 comprises a local learning terminal and/or a remote learning terminal, wherein the local learning terminal performs data interaction with the teaching controller 100 based on a local area network, and the remote learning terminal performs data interaction with the teaching controller 100 based on a cloud platform. On the basis of remote teaching, the cloud platform comprises a resource list, and updates, when there is new teaching information at the teaching controller 100, the teaching information to the resource list.

Preferably, in the step S4:

after the remote learning terminal establishes a connection with the teaching controller 100, the cloud platform starts a resource pushing procedure: first acquiring a resource list and determining whether the resource list is updated, and if so, the cloud platform pushing, to the remote learning terminal 103, the teaching data output by the teaching controller 100. The cloud computing virtualization technology can regard the resources of a physical layer as a “resource pool”, and manage same through middleware in a cloud environment. Because the tasks that a user needs to compute are different, the resource scheduling of different users will also be run in a specific environment according to demand conditions and related rules, and operation tasks all have one or more processes in the system.

There are two methods to implement resource scheduling tasks: one is to arrange different machines according to different computing tasks using resources; and the other one is to transfer the computing tasks to other machines. For example, multiple functions, such as user task scheduling including works in the aspects of resource management, security management, user management and task management, and resource status monitoring, node failure shielding and user identity management can all be specifically implemented in a resource management environment for cloud computation.

Preferably, in the step S3:

For the speaker segmentation and clustering, the teaching controller 100 performs analysis processing on the received speech information, so as to extract the speech information about each speaker, with the specific approach therefor being as follows:

The teaching controller 100 comprises a speaker segmentation module, a speaker clustering module and a voiceprint recognition module, which are used for performing processing such as speaker segmentation, speaker clustering and voiceprint recognition on the collected speech information, so as to extract speech information about each speaker and recognize the identity of the speaker according to an existing trained voiceprint template. Furthermore, a speaker identifier and a unified timestamp which is generated by the system are added to the extracted speech, so that the user can select to play a speech that he or she wants to hear when reviewing by means of on-demand playback over network, for example, to play a speech from a teacher of what he or she wants to hear, while shielding the other speeches, or to select to play back speeches of the teacher and the user himself or herself when he or she wants to hear what the teacher and the user himself or herself said.

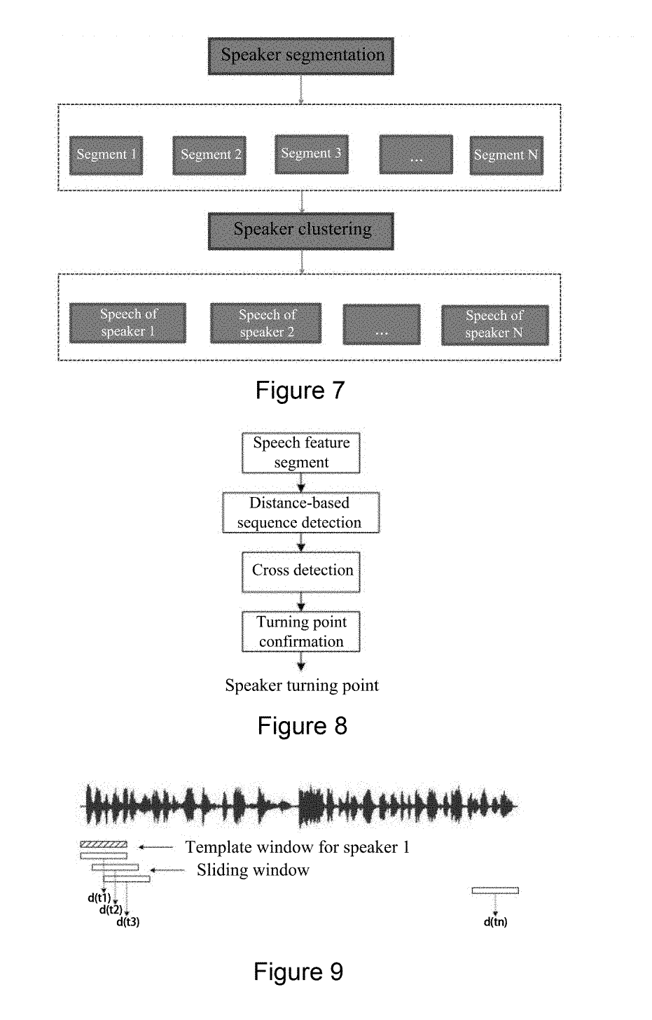

As shown in FIG. 7, it is a schematic diagram of a process of speaker segmentation and clustering according to the present disclosure.

The teaching controller 100 first performs endpoint detection processing on the obtained speech information in which only a portion with speech is extracted and a mute portion is removed, and performs speaker segmentation and clustering and voiceprint recognition processing on the extracted portion with speech. The purpose of the speaker segmentation is to find a turning point at which the speaker changes, so that an input speech is segmented into speech segments according to speakers: segment 1, segment 2, segment 3 . . . , segment N (for example: segment 1 and segment 3 may be speeches from the same person, but because there is a speech of another person therebetween, the two segments are cut apart by a speaker turning point), whereas each speech segment only contains speech information about a single speaker; and the purpose of the speaker clustering is to aggregate speech segments from the same speaker so that each class only contains data of one speaker, and data of each person are contained in one class of data as much as possible (in the example above, segment 1 and segment 3 can be combined together).

The speaker clustering in the present disclosure is performed by using LSP (Line Spectrum Pair) features, that is, extracting LSP feature data from the original speech for subsequent calculations.

(I) Speaker Segmentation

The speaker segmentation focuses on looking for a turning point for speaker switching, including single turning point detection and multiple turning points detection:

(1) Single Turning Point Detection:

as shown in FIG. 8, the single turning point detection comprises the steps of: a speech feature segment extraction, a distance-based sequence detection, a cross detection and a turning point confirmation. The speech feature segment extraction is in the same manner as the foregoing corresponding manner, or can directly use the foregoing extracted speech feature, which will not be redundantly described herein.

1) Distance-Based Sequence Detection:

as shown in FIG. 9, it is a schematic diagram of distance-based single-turning point sequence detection. The detection method assumes that there is no turning point within an initial small period of time interval of a speech segment. Firstly, a speech segment (1 to 3 seconds) at the very beginning of the speech is taken as a template window, and then the distance between this template and each sliding segment (with the same length as that of the template) is calculated, and in the present disclosure, a “generalized likelihood ratio” is adopted as a metric distance, so that a distance curve can be obtained, where d(t) represents a distance value between a sliding window at time t and the template window for speaker 1.

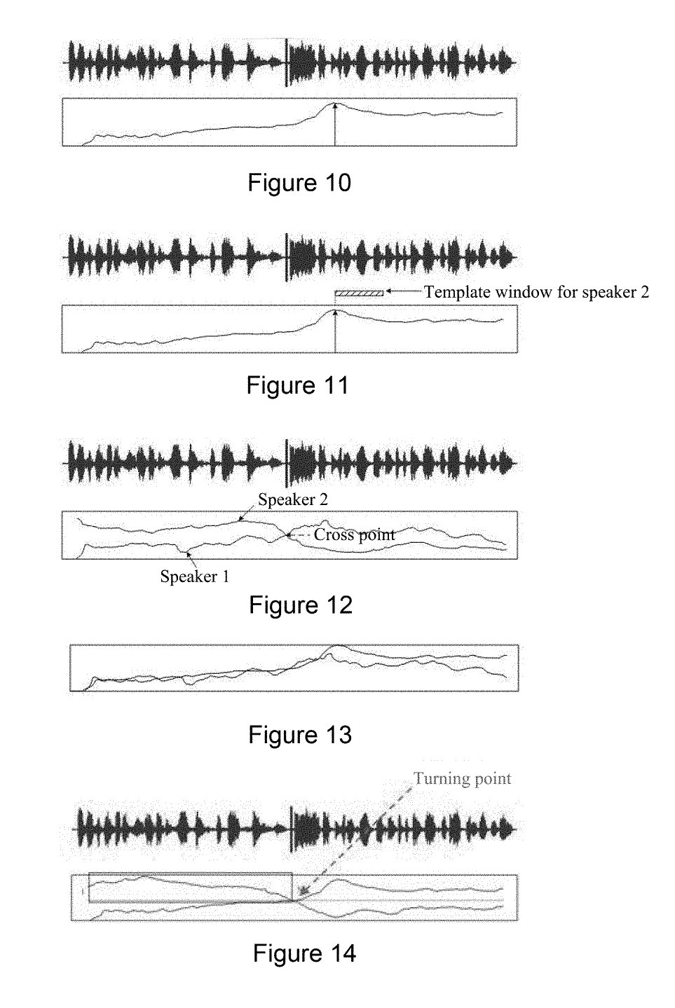

As shown in FIG. 10, it is the distance curve after the sequence detection, in which when the sliding window is within the range of the first speaker, speeches in both the template segment and the moving window are speeches from the first speaker, so the distance value is small. When the moving window reaches the range of the second speaker, the speech in the sliding window changes to be a speech from the second speaker, so the distance value gradually increases. Therefore, it can be assumed that when the distance value is maximum, it is most likely to have in the vicinity thereof a speech of the second speaker.

2) Cross Detection:

as shown in FIG. 11, after the sequence detection is completed, a template window for the second speaker is determined by looking for the maximum point of the distance curve.

After the template for the second speaker is found, a second distance curve can be obtained with the same method as described above. As shown in FIG. 12, the crossing of the two curves is the speaker turning point.

3) Turning Point Confirmation:

As shown in FIG. 13, during cross detection, if a speech from the first speaker is mistakenly used as a speech template for the second speaker, a false-alarm error may be generated. In order to reduce the false-alarm error, it is necessary to preferably confirm each turning point. The confirmation of the turning point is as shown in formula 1:

$$\{ \begin{matrix}{\sum }_{i = 0}^{N} sign ( d ( i ) - {d}_{cross} ) > 0 & accepting the turning point \\ {\sum }_{i = 0}^{N} sign ( d ( i ) - {d}_{cross} ) < 0 & rejecting the turning point\end{matrix}$$

In the above-mentioned formula, sign(⋅) is a sign function, and d_{cross} is a distance value at the crossing of two distance curves,

wherein by using a section of a distance curve of speaker 2 from a start to a cross point (as shown in a box part in FIG. 14), d (i) in the formula (1) is a distance calculated within this section, and if the final result is positive, this point is accepted as the speaker turning point; and if the final result is negative, this point is rejected to be the speaker turning point.

(2) Multiple Turning Points Detection:

a plurality of speaker turning points in a whole speech segment are to be found, which can be completed on the basis of the single turning point detection, comprising:

step 1): firstly, setting a large time window (with a length of 5 to 15 seconds), and performing the single turning point detection within the window;

step 2): if no speaker turning point is found in the preceding step, moving the window backward (by 1 to 3 seconds), and repeating step 1 until a speaker turning point is found or the speech segment ends;

step 3): if a speaker turning point is found, recording this turning point and setting a starting point of the window at this turning point, and repeating steps 1) and 2).

Through the above-mentioned steps, all the turning points for the plurality of speakers can be found, and the speech is segmented according to the turning points: segment 1 to segment N.

Thus, the speaker segmentation can be completed by the single turning point detection and the multiple turning points detection.

(II) Speaker Clustering

After the speaker segmentation is completed, next, these segments are clustered by means of the speaker clustering, and the segments from the same speaker are combined together: the speaker clustering is a specific application of the clustering technique in speech signal processing, and the purpose thereof is to classify speech segments so that each class only contains data from the same speaker, and the data from the same speaker are merged into the same class.

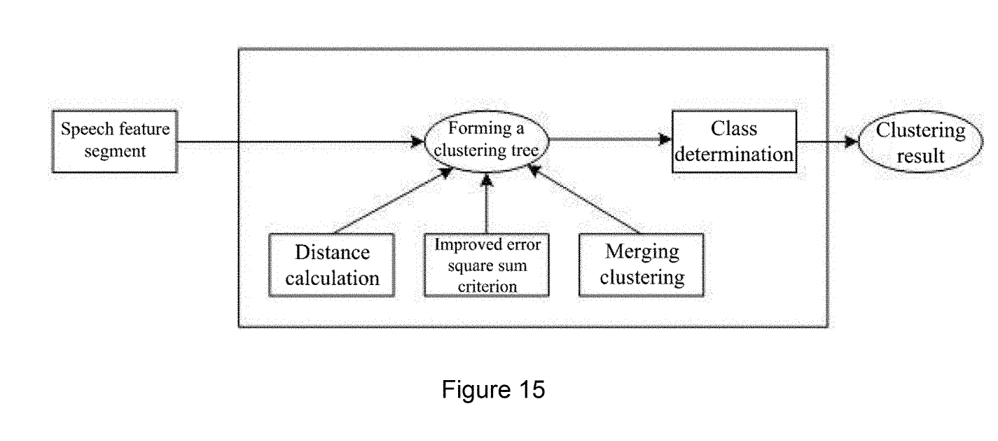

For the segmentation and clustering, the present disclosure proposes an improved hierarchical clustering method (IHC), which performs merging and determines the number of classes by minimizing an intra-class error square sum, with the specific steps being as shown in FIG. 15:

considering a set of speech segments X={X₁, X₂, . . . , X_{N}}, where Xₙ represents a feature sequence corresponding to a certain speech segment; XN represents the last feature in this set, whereas Xn makes a general reference; and “where Xₙ represents a feature sequence corresponding to one speech segment.” means that each x in the set is a feature sequence. The speaker clustering means that a division C={c₁, c₂, . . . , c_{K}} of the set X needs to be found, while cₖ only contains speech information about one speaker, and speech segments from the same speaker are only classified into cₖ.

(1) Distance Calculation

As with the method for determining the calculated distance of the speaker turning point, a “generalized likelihood ratio” is adopted as a metric distance.

(2) Improved Error Square Sum Criterion

The error square sum criterion is a criterion in which the intra-class error square sum is minimized. In the application of the speaker clustering, the distance between data from the same speaker is small, whereas the distance between data from different speakers is large, and therefore the error square sum criterion can achieve a good effect.

In summary, in the first step of the IHC algorithm, the distance metric is used as the similarity and the improved error square sum criterion is used as a criterion function, and each two, namely, the distance metric and the improved error square sum criterion, are gradually merged, so as to finally form a clustering tree.

(3) Class Determination

In the speaker clustering, an important part is to automatically determine the number of classes that exist objectively in the data, that is, determining how many speakers there are. The present disclosure adopts a class determination method based on hypothesis testing, which uses the principle of hypothesis testing to test each merging operation on the clustering tree to check the reasonableness of the merging thereof, so as to determine the final number of classes. Once an unreasonable merging is found, it is considered that the number of classes prior to merging is the final number of speaker classes.

For (1) and (2), different distance calculation methods and different clustering criteria are adopted, so that the correctness and effect of clustering can be improved; and for (3), a hypothesis-based testing method is used, so that it is not necessary to consider the number of specified classes during clustering, because it is often impossible to determine in advance how many people there are speaking; however, by means of this method, several corresponding classes can be clustered according to actual conditions.

Preferably, speaker matching is performed according to the existing voiceprint model, wherein the voiceprint model can be obtained from prior trainings, and since the number of persons in the class taking a lesson is substantially fixed, it is relatively easy to generate the voiceprint model. For a specific class taking the lesson, it can be necessary to only retrieve voiceprint models of students in this class for quick comparison each time, thus improving the efficiency of voiceprint recognition. The training and recognition of a voiceprint model are relatively well-known contents and are not the focus of the present disclosure, and will not be described herein again.

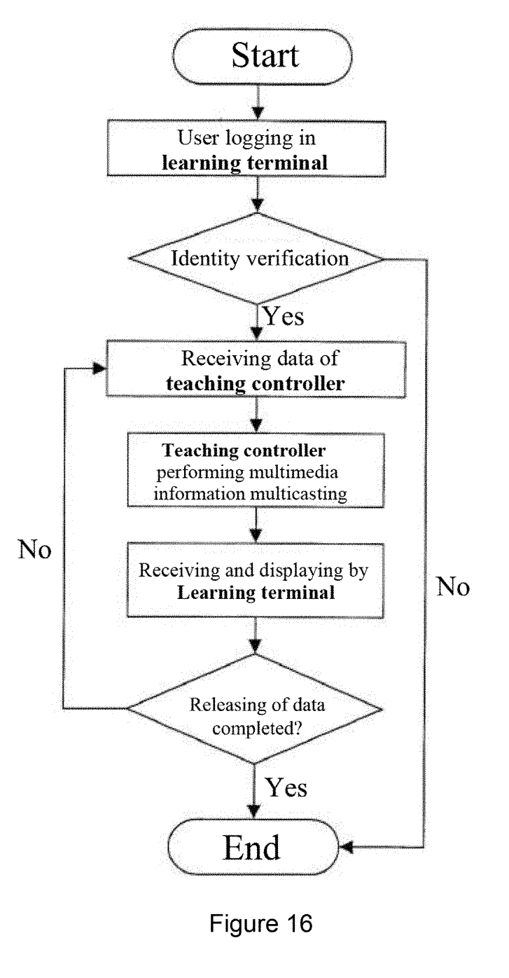

As shown in FIG. 16, it is a flowchart of receiving and playing, by the learning terminal 103, the teaching data in real time, which comprises:

step S41, logging in, by the user, the learning terminal 103 after passing an identity verification;

step S42, receiving, by the learning terminal 103, the teaching data sent by the teaching controller 100;

step S43, obtaining, by the learning terminal 103 by parsing the teaching data, the real-time image, the action data and the speech information, and displaying same on the learning terminal 103, such as parsing and displaying the received real-time image by means of DirectX; and

step S44, determining whether the receiving of the teaching data is completed, and if so, ending the receiving process, and if not, returning to the step S42.

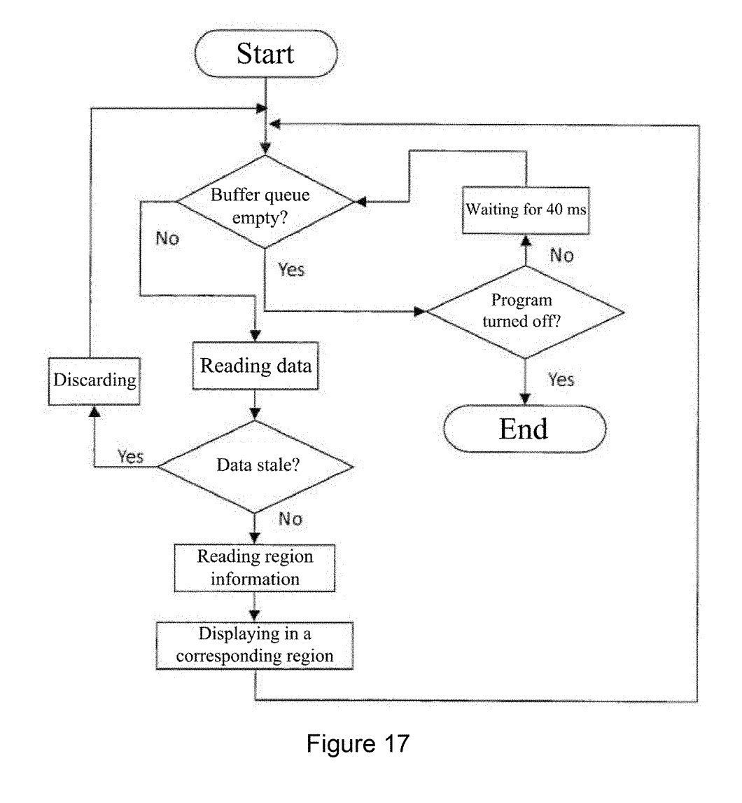

As shown in FIG. 17, the learning terminal 103 is provided with a buffer for accommodating a preset number of real-time images, and when receiving a real-time image, the learning terminal 103 first determines whether the real-time image can be loaded into the buffer and compares the serial number of the received image with the serial number of an image displayed by the learning terminal 103, and writes the received image into the buffer if the difference between the serial numbers is less than the number of real-time images that the buffer can accommodate, and discards the real-time image and continues with the comparison if the difference between the serial numbers is greater than the number of real-time images that the buffer can accommodate, and re-receives a real-time image sent by the teaching terminal until the real-time image can be stored to the buffer.

When the difference between the serial numbers is greater than the number of real-time images that the buffer can accommodate, the learning terminal first determines whether the received image frame is a synchronous frame, if so, checks whether the image frame at the tail of a buffer queue is a synchronous frame, and if so, discards the image frame and places the received new image frame at a queue-tail position, and if not, continues with the query for a synchronous frame from the buffer queue so as to find a synchronous frame, and then discards the synchronous frame and the received image; and if there is no synchronous frame in the queue, the learning terminal places the received image frame at the tail of the queue to cover original data, and waits for the completion of the reception of synchronous frames through repeated receptions and displays the synchronous frames on the learning terminal 103.

The serial number of the image can be a sequential number, and the difference between the serial numbers is subtraction in mathematics, and if the difference is greater than the size of the buffer, it is indicated that the buffer is full. At this time, the received images cannot be added to the buffer, and the newly received data can not be added to the buffer until the buffer is not full (the difference is less than the size of the buffer). The played images are all sequentially taken from the buffer. Images that are not stored into the buffer are considered as being discarded. The number of images in the buffer is changing (playing, so that the images therein are reduced; accepting, so that the number of images is increased, but the number will not exceed a preset size of the buffer at most).

In order to achieve a real-time effect, some synchronous frames are required (which can be transmitted like images, but do not represent specific image data). In the case where a currently received frame is a synchronous frame: (1) if a frame at the tail of the queue is a synchronous frame, it is indicated that synchronization is not completed, the synchronous frame at the tail of the queue is replaced by a new synchronous frame, and acceptance is continued with; (2) if a frame at the tail of the queue is not a synchronous frame, query for a synchronous frame from the queue is made, and image frames from the queried synchronous frames to an image frame accepted at the tail of the queue are all discarded, because these image frames are not synchronized, or these images are received before the synchronization is completed, and playing these images will not achieve a real-time (live) effect; and (3) if there is no synchronous frame in the queue, it is indicated that frames in the queue are all image frames, and these image frames are also received before the synchronization is completed, and should be discarded.

After the reception of all the synchronous frames is completed, it is proved that the synchronization process is finished, and images received afterwards are all in real time with the network, which can achieve a real-time “live” effect. Image data received asynchronously are mostly delayed.

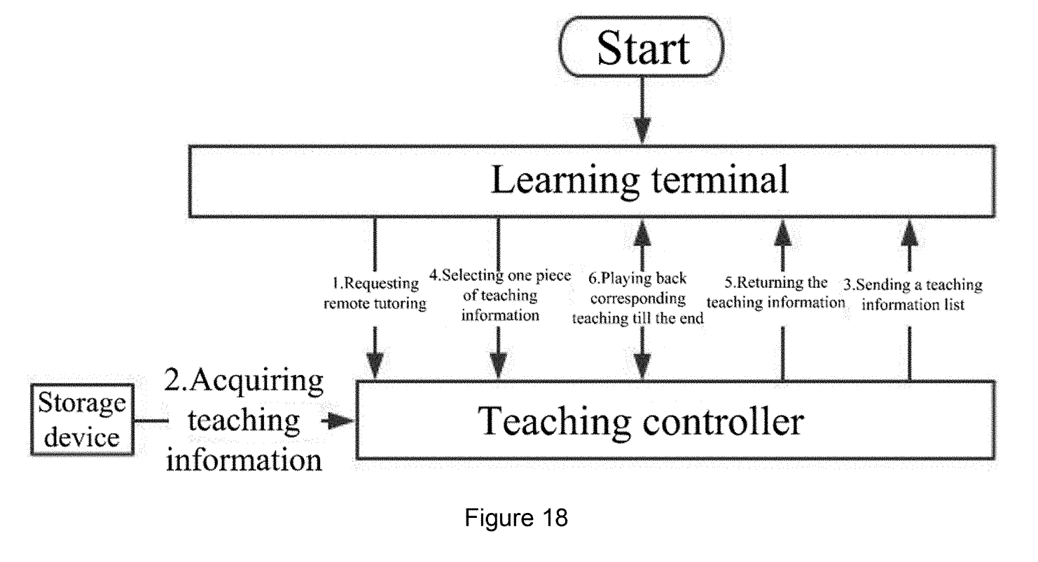

As shown in FIG. 18, it is a flowchart of on-demand playback in a multimedia interactive teaching method of the present disclosure, specifically comprising:

step S51, sending, by the learning terminal 103 of the user, an on-demand playback request to the teaching controller 100 over the network;

step S52, acquiring, by the teaching controller 100 in responsive to the on-demand playback request, a corresponding teaching information list on the storage device 107 according to requested content, and sending the teaching information list to the learning terminal 103;

step S53, selecting, by the user on the learning terminal 103, desired pieces of information from the teaching information list, wherein these pieces of information comprise the image information, the action information, as well as the speech information which is distinguished in accordance with the speakers, and the user can select one of these pieces of information, such as the speech information, and the user can only select a speech from the teacher and a speech from the user himself or herself;

step S54, sending, by the teaching controller 100 according to the student user's selection, corresponding teaching information to the learning terminal 103; and

step S55, reconstructing, by the learning terminal 103 in accordance with timestamps, the received teaching information, and displaying the reconstructed teaching information locally.

Compared with the existing system and method, the teaching system and teaching method of the present disclosure have the following technical effects:

1. In combination with techniques such as a teaching controller, a teaching APP or a PC software client, a high-speed photographic instrument, an electronic whiteboard, a wireless remote controller, an LED display screen, the traditional passive class-attending is transformed into active class-attending, and teachers do not need to stand on the platform to give a lesson but can assist in giving the lesson in the classroom by means of remote control at any time, and after the combination with the electronic whiteboard, the whole class is more interesting, and it is helpful for students to improve their learning efficiency.

2. With effective combination with the high-speed photographic instrument, especially in experimental courses such as the physical/chemical, students can see each operation of the teacher more realistically and clearly, so as to thoroughly understand the experimental objective and the experimental process. In particular, the improved high-speed photographic instrument can realize a wireless data transmission function, and the structure thereof is compact, so that the data transmission can be guaranteed in distance.

3. With a speech collection apparatus installed in the classroom, the speeches of the students participating in discussions during the class are collected, and the speeches of the students participating in discussions when each question is discussed at each stage are recorded and are separately saved as files by means of speech clustering analysis via the teaching controller, so that the students can review their participation in the discussions in the class, the initiative of the students to participate in the in-class discussions is motivated, and the analysis of speech logic by the students after answering questions is facilitated, which helps them to improve the way to answer questions.

4. The wireless remote controller has basic functions, such as speech analysis, operation information extraction and instruction matching, thereby realizing speech control, and also can support the functions such as an analog mouse, a virtual keyboard, an analog drawing board, thereby realizing more flexible and diverse wireless control.

5. The whole teaching system is easy to deploy and flexible to operate, and can be associated with more multimedia devices through the teaching controller, and can give a lesson and explain the exercise through the electronic whiteboard, so that the entire teaching process can be synchronized to the learning terminal.

The preferred embodiments of the present disclosure are introduced above, and are intended to make the spirit of the present disclosure clearer and facilitate the understanding thereof, but not to limit the present disclosure. Any modification, substitution and improvement made within the spirit and principle of the present disclosure shall be included in the protection scope of appended claims of the present disclosure.

What is claimed is:

1. A multimedia interactive teaching system, comprising a teaching controller, a learning terminal, a recording device, a speech collection device and a storage device, wherein
the recording device is used for acquiring a real-time image and action data;
the speech collection device is used for collecting real-time in-class speech information;
the teaching controller is used for sending teaching information collected by the recording device and the speech collection device to the learning terminal and/or a display screen additionally arranged for centralized presentation; and
the storage device is used for storing the teaching information collected by the recording device and the speech collection device, so that a user can review an in-class teaching process by means of on-demand play over network.

2. The system of claim 1, wherein
the teaching controller comprises a speaker segmentation module, a speaker clustering module and a voiceprint recognition module, which are respectively used for performing speaker segmentation, speaker clustering and voiceprint recognition processing on the collected speech information, so as to extract speech information about each speaker and recognize the identity of the speaker according to a voiceprint template obtained from training.

3. The system of claim 2, wherein
a speaker identity identifier and a timestamp identifier which is unifiedly generated by the system are added to the extracted speech information, so as to form a series of independent pieces of speech information taking a speaker identity as an identifier and having a timestamp, and then save same.

4. The system of claim 3, wherein
when reviewing the in-class teaching process by means of on-demand play over network, the user first selects a speech that he or she wants to hear by selecting a speaker, and then plays the speech.

5. The system of claim 2, wherein
the speaker segmentation is used for looking for a turning point for speaker switching, including single turning point detection and multiple turning points detection, wherein
the single turning point detection comprises a distance-based sequence detection, a cross detection and a turning point confirmation; and
the multiple turning points detection is used for looking for a plurality of speaker turning points in a whole speech segment, and is completed on the basis of the single turning point detection, comprising:
step 1): firstly, setting a large time window with a length of 5 to 15 seconds, and performing the single turning point detection within the window;
step 2): if no speaker turning point is found in the preceding step, moving the window backward by 1 to 3 seconds, and repeating step 1 until a speaker turning point is found or the speech segment ends; and
step 3): if a speaker turning point is found, recording this turning point and setting a starting point of the window at this turning point, and repeating steps 1) and 2).

6. The system of claim 5, wherein a confirmation formula for the turning point is:
$$\{ \begin{matrix}{\sum }_{i = 0}^{N} sign ( d ( i ) - {d}_{cross} ) > 0 & accepting the turning point \\ {\sum }_{i = 0}^{N} sign ( d ( i ) - {d}_{cross} ) < 0 & rejecting the turning point\end{matrix}$$
where sign(⋅) is a sign function, and d_{cross} is a distance value at the crossing of two distance curves; and
wherein by using a section of a distance curve of the speaker from a start to a cross point, d (i) in the formula is a distance calculated within this section, and if a final result is positive, this point is accepted as the speaker turning point; and if the final result is negative, this point is rejected to be the speaker turning point.

7. The system of claim 1, wherein
the recording device comprises a teaching high-speed photographic instrument and an electronic whiteboard, wherein
the teaching high-speed photographic instrument is used for acquiring the real-time image and outputting same to the teaching controller, and
the electronic whiteboard is used for acquiring the action data and outputting same to the teaching controller.

8. The system of claim 7, wherein
the teaching high-speed photographic instrument comprises a working table and a wireless transmission module, wherein
an arm lamp is arranged respectively at each of both sides of the working table, and
a transmission antenna of the wireless transmission module is arranged on a non-light-emitting side part of at least one of the arm lamps.

9. The system of claim 1, further comprising
a wireless remote controller for implementing wireless control of the teaching controller, wherein
the wireless remote controller comprises a touch screen, a microphone, an external microphone jack and a wireless transmission module.

10. The system of claim 9, wherein
the wireless remote controller further comprises a speech recognition module, an instruction storage module and an instruction matching module, wherein
the speech recognition module is used for recognizing the speech information input by the user, and if a set action character is detected, extracting operation information contained in the speech after the action character while not transmitting this speech segment to the teaching controller, and if no set action character is detected, synchronously transmitting the speech information to the teaching controller;
the instruction storage module is used for storing information about instructions that can control the teaching controller; and
the instruction matching module is used for matching the operation information with the instructions stored in the instruction storage module, and implementing corresponding instruction operations after the matching is successful.

11. The system of claim 10, wherein the touch screen is used for simulating a virtual keyboard and typing characters with the virtual keyboard;
simulating a mouse button to implement a mouse click operation; and
acquiring a sliding track and generating a hand-drawn graphic according to the sliding track.

12. The system of claim 10, wherein
the wireless remote controller records the extracted operation information and the instruction matching therewith, and displays same on the touch screen of the wireless remote controller, and displays common instructions in a fixed position on the touch screen, so that the user repeats such an instruction action through click operations.

13. The system of claim 10, wherein the wireless remote controller further comprises an external microphone jack which is arranged at the bottom of the wireless remote controller and is used for acquiring the speech information via an outer dedicated microphone.

14. The system of claim 10, wherein
the teaching controller regularly updates the instructions stored in the wireless remote controller.

15. The system of claim 10, wherein
the speech information transmitted to the teaching controlled by the wireless remote controller is also saved to the storage device; and
the teaching controller further comprises a speaker deduplication module for removing duplicated speeches originating from the wireless remote controller and the speech collection device according to a voiceprint model.

16. A multimedia interactive teaching method, comprising:
step S1, turning on a teaching controller, and establishing, by a recording device, a learning terminal, a speech collection device and a storage device, respectively, a connection with the teaching controller;
step S2, acquiring, by the recording device, a real-time image and action data and transmitting same to the teaching controller, and acquiring, by the speech collection device, in-class speech information and transmitting same to the teaching controller;
step S3, processing, by the teaching controller, the received real-time image, action data and speech information, and then storing same to the storage device, wherein the storage device is a local memory or a network cloud memory and any combination thereof;
step S4, sending, by the teaching controller, teaching data of one or any combination of the received real-time image, action data and speech information to the learning terminal and/or a display screen additionally arranged for centralized presentation;
step S5, receiving and playing, by the learning terminal, the teaching data sent by the teaching controller; and
step S6, accessing the teaching controller over a network, and obtaining at least one of the real-time image, the action data and the speech information stored on the storage device, thereby implementing the playback of an in-class teaching process.

17. The method of claim 16, wherein in the step S3, the process of processing, by the teaching controller, the received teaching data comprises:
speaker segmentation, speaker clustering and voiceprint recognition, which are respectively used for performing speaker segmentation, speaker clustering and voiceprint recognition processing on the collected speech information, so as to extract speech information about each speaker and recognize the identity of the speaker according to a voiceprint template obtained from training.

18. The method of claim 17, wherein
a speaker identity identifier and a timestamp identifier which is unifiedly generated by a system are added to the extracted speech information, so as to form a series of independent pieces of speech information taking a speaker identity as an identifier and having a timestamp, and then save same.

19. The method of claim 18, wherein in step S6,
when reviewing a class by means of on-demand play over network, the user first selects a speech that he or she wants to hear by selecting a speaker, and then plays the speech.

20. The method of claim 19, wherein
the speaker segmentation is used for looking for a turning point for speaker switching, including single turning point detection and multiple turning points detection, wherein
the single turning point detection comprises a distance-based sequence detection, a cross detection and a turning point confirmation; and
the multiple turning points detection is used for looking for a plurality of speaker turning points in a whole speech segment, and is completed on the basis of the single turning point detection, comprising:
step 1): firstly, setting a large time window with a length of 5 to 15 seconds, and performing the single turning point detection within the window;
step 2): if no speaker turning point is found in the preceding step, moving the window backward by 1 to 3 seconds, and repeating step 1 until a speaker turning point is found or the speech segment ends; and
step 3): if a speaker turning point is found, recording this turning point and setting a starting point of the window at this turning point, and repeating steps 1) and 2).

21. The method of claim 20, wherein a confirmation formula for the turning point is:
$$\{ \begin{matrix}{\sum }_{i = 0}^{N} sign ( d ( i ) - {d}_{cross} ) > 0 & accepting the turning point \\ {\sum }_{i = 0}^{N} sign ( d ( i ) - {d}_{cross} ) < 0 & rejecting the turning point\end{matrix}$$
where sign(⋅) is a sign function, and d_{cross} is a distance value at the crossing of two distance curves; and
wherein by using a section of a distance curve of the speaker from a start to a cross point, d (i) in the formula is a distance calculated within this section, and if a final result is positive, this point is accepted as the speaker turning point; and if the final result is negative, this point is rejected to be the speaker turning point.

22. The method of claim 16, wherein
the recording device comprises a teaching high-speed photographic instrument and an electronic whiteboard, wherein
the teaching high-speed photographic instrument is used for acquiring the real-time image and outputting same to the teaching controller, and
the electronic whiteboard is used for acquiring the action data and outputting same to the teaching controller.

23. The method of claim 22, wherein
the teaching high-speed photographic instrument comprises a working table and a wireless transmission module, wherein
an arm lamp is arranged respectively at each of both sides of the working table, and
a transmission antenna of the wireless transmission module is arranged on a non-light-emitting side part of at least one of the arm lamps.

24. The method of claim 16, wherein
the system further comprises a wireless remote controller for implementing wireless control of the teaching controller, wherein
the wireless remote controller comprises a touch screen, a microphone, an external microphone jack and a wireless transmission module.

25. The method of claim 24, wherein
the wireless remote controller further comprises a speech recognition module, an instruction storage module and an instruction matching module, wherein
the speech recognition module is used for recognizing the speech information input by the user, and if a set action character is detected, extracting operation information contained in the speech after the action character while not transmitting this speech segment to the teaching controller, and if no set action character is detected, synchronously transmitting the speech information to the teaching controller;
the instruction storage module is used for storing information about instructions that can control the teaching controller; and
the instruction matching module is used for matching the operation information with the instructions stored in the instruction storage module, and implementing corresponding instruction operations after the matching is successful.

26. The method of claim 24, wherein the touch screen is used for
simulating a virtual keyboard and typing characters with the virtual keyboard;
simulating a mouse button to implement a mouse click operation; and and/or
acquiring a sliding track and generating a hand-drawn graphic according to the sliding track.

27. The method of claim 24, wherein
the wireless remote controller records the extracted operation information and the instruction matching therewith, and displays same on the touch screen of the wireless remote controller, and displays common instructions in a fixed position on the touch screen, so that the user repeats such an instruction action through click operations.

28. The method of claim 24, wherein the wireless remote controller further comprises an external microphone jack which is arranged at the bottom of the wireless remote controller and is used for acquiring the speech information via an outer dedicated microphone.

29. The method of claim 24, wherein
the teaching controller regularly updates the instructions stored in the wireless remote controller.

30. The method of claim 24, wherein
the speech information transmitted to the teaching controller by the wireless remote controller is also saved to the storage device; and
the teaching controller further comprises a speaker deduplication module for removing duplicated speeches originating from the wireless remote controller and the speech collection device according to a voiceprint model.

31. The method of claim 16, wherein in step S5, the process of receiving and playing, by the learning terminal, the teaching data comprises:
step S41, logging in, by the user, the learning terminal 103 after passing an identity verification;
step S42, receiving, by the learning terminal 103, the teaching data sent by the teaching controller 100;
step S43, obtaining, by the learning terminal 103 by parsing the teaching data, the real-time image, the action data and the speech information, and displaying same on the learning terminal 103, comprising parsing and displaying the received real-time image by means of DirectX; and
step S44, determining whether the receiving of the teaching data is completed, and if so, ending the receiving process, and if not, returning to the step S42.

32. The method of claim 31, wherein
the learning terminal is provided with a buffer for accommodating a preset number of real-time images, and when receiving a real-time image, the learning terminal first determines whether the real-time image can be loaded into the buffer and compares the serial number of the received image with the serial number of an image displayed by the learning terminal, and writes the received image into the buffer if the difference between the serial numbers is less than the number of real-time images that the buffer can accommodate, and discards the real-time image and continues with the comparison if the difference between the serial numbers is greater than the number of real-time images that the buffer can accommodate, and re-receives a real-time image sent by the teaching terminal until the real-time image can be stored to the buffer.

33. The method of claim 32, wherein
when the difference between the serial numbers is greater than the number of real-time images that the buffer can accommodate, the learning terminal first determines whether the received image frame is a synchronous frame, if so, checks whether the image frame at the tail of a buffer queue is a synchronous frame, and if so, discards the image frame and places the received new image frame at a queue-tail position, and if not, continues with the query for a synchronous frame from the buffer queue so as to find a synchronous frame, and then discards the synchronous frame and the received image; and if there is no synchronous frame in the queue, the learning terminal places the received image frame at the tail of the queue to cover original data, and waits for the completion of the reception of synchronous frames through repeated receptions and displays the synchronous frames on the learning terminal.

34. The method of claim 16, wherein in the step S6, the on-demand playback process is as follows:
step S51, sending, by the learning terminal of the user, an on-demand playback request to the teaching controller over the network;
step S52, acquiring, by the teaching controller in responsive to the on-demand playback request, a corresponding teaching information list according to the content of the request, and sending the teaching information list to the learning terminal;
step S53, selecting, by the user on the learning terminal, desired pieces of information from the teaching information list, wherein these pieces of information comprise the image information, the action information, as well as the speech information which is distinguished in accordance with the speakers;
step S54, sending, by the teaching controller according to the user's selection, corresponding teaching information to the learning terminal; and
step S55, reconstructing, by the learning terminal in accordance with the timestamps, the received teaching information, and displaying the reconstructed teaching information locally.
